(19) United States
(12) Patent Application Publication
(10) Pub. No.: US 2010/0058913 A1
(43) Pub. Date: Mar. 11, 2010

(54) MICROTOME HAVING A CASSETTE CHANGING APPARATUS

(75) Inventor: Roland Walter, Reilingen (DE)

Correspondence Address: ALEXANDER R SCHLEE;SCHLEE IP INTERNATIONAL P.C., 3770 HIGHLAND AVENUE, SUITE 203, MANHATTAN BEACH, CA, 90266, US

(73) Assignee: LEICA BIOSYSTEMS NUSSLOCH GMBH, Nussloch (DE)

(21) Appl. No.: 12/557,456

(22) Filed: Sep. 10, 2009

(30) Foreign Application Priority Data
Sep. 9, 2008 (DE) 102008046395.7

(51) Int. Cl. G01N 1/06; B26D 7/01

(52) U.S. Cl. 83/648; 83/915.5; 83/415

(57) ABSTRACT

A microtome is described, having a cassette changing apparatus that comprises a stationary guide bar. The latter guides a second slider that is a guide for the first slider. The first and the second slider are coupled to one another in such a way that a movement of the second slider along the stationary guide bar operates a movement of the first slider along with the second slider and additionally relative to the second slider.

### CROSS-REFERENCE TO RELATED APPLICATION

This application claims the priority of the German patent application DE 102008046395.7 having a filing date of Sep. 9, 2008. The entire content of this prior German patent application DE 102008046395.7 is herewith incorporated by reference.

### BACKGROUND OF THE INVENTION

The invention relates to a microtome having a cassette changing apparatus. DE 20 2004 006 265 U1 discloses a microtome having a cassette changing apparatus. The microtome is embodied to generate thin sections. It contains a sample receptacle for samples embedded into a cassette, a magazine having a coding system and compartments for receiving prepared cassettes, and a handling device for controllable removal of a cassette and positioning on the sample receptacle, and for return into the magazine.

### SUMMARY OF THE INVENTION

The object on which the invention is based is to create a microtome having a cassette changing apparatus that enables simple, fast, and/or safe processing of cassettes having samples.

This is achieved by a microtome comprising a cassette changing apparatus that comprises: a stationary guide bar; a first slider adapted to displace a cassette; a second slider that is guided movably by the stationary guide bar and adapted to guide the first slider; and a coupling means adapted to couple the first and the second slider to each other such that a movement of the second slider along the stationary guide bar operates a movement of the first slider along with the second slider and additionally relative to the second slider.

The invention is notable for a microtome having a cassette changing apparatus. The cassette changing apparatus comprises a stationary guide bar. A first slider is movably guided by the stationary guide bar. The first slider is provided for the displacement of a cassette.

Thanks to the first slider, which slides the cassette into a processing apparatus when used as intended, an operator of the microtome can maintain a safe distance from a sectioning knife of the microtome. This is advantageous in particular when the cassette changing apparatus, in particular the first slider, is operated manually. The first slider furthermore makes possible automatic processing of the cassette, and thus simple and fast processing of the cassette, in particular of the sample in the cassette. “Stationary” means in this connection that the stationary guide bar is retained in stationary fashion relative to the microtome.

In an advantageous embodiment, the cassette changing apparatus comprises a second slider. The second slider is guided movably in the stationary guide bar, and constitutes a guide for the first slider. The first and the second slider are coupled to one another in such a way that a movement of the second slider along the stationary guide bar brings about a movement of the first slider along with the second slider, and additionally relative to the second slider. Because the first slider that is provided for displacement of the cassette is moved along its guide in the second slider and additionally along with the second slider, this makes possible a compact design for the cassette changing apparatus and thus for the microtome. Furthermore, in the context of manual operation of the second slider, a safety distance for an operator of the microtome can be additionally increased, since the distance traveled by the first slider relative to the stationary guide bar is greater than the travel of the second slider, and thus also greater than the distance that an operator's hand must travel.

The second slider is arranged mechanically between the stationary guide bar and the first slider. The stationary guide bar can at least partly surround the first and/or the second slider, or can be at least partly surrounded by the first and/or the second slider.

In a further advantageous embodiment, the cassette changing apparatus comprises a removal bar. The removal bar is arranged so that the cassette is displaceable into the removal bar by means of the first and/or the second slider. This contributes particularly effectively to a simple and compact design for the cassette changing apparatus, since the slider or sliders have the dual function of sliding the cassette into the processing apparatus and sliding it out of the processing apparatus into the removal bar.

In a further advantageous embodiment, the stationary guide bar is embodied as a guide for at least the one cassette. The dual function of the stationary guide bar thereby achieved contributes in simple fashion to the compact design. It is particularly advantageous in this context if the first and/or the second slider are at least partly surrounded by the stationary guide bar.

In a further advantageous embodiment, the first and the second slider are coupled to one another in such a way that movement of the second slider by an amount equal to a first unit results in a movement of the first slider by an amount equal to a multiple of the first unit. This contributes effectively to the particularly compact design, and makes possible a particularly large safety distance for the operator. The multiple of the first unit can also be a non-integral multiple.

It is particularly advantageous in this connection if the first slider comprises a first toothed rack, and the stationary guide bar comprises a second toothed rack. A gear is mounted rotatably on the second slider, and is arranged between the first and the second toothed rack in such a way that teeth of the gear engage on the one hand into the first toothed rack and on the other hand into the second toothed rack. This enables, in simple fashion, ratio conversion of the motion from the second slider to the first slider.

In a further advantageous embodiment, the first and/or the second slider are coupled to a drive apparatus in order to move the first or the second slider. This makes it possible, in simple fashion, to move the corresponding slider automatically.

In a further advantageous embodiment, the guides for the first and/or the second slider are embodied as a dovetail guide. This enables guidance for the first and the second slider in simple and secure fashion. The dovetail guide preferably encompasses a recess, dovetail-shaped in profile, in the outer of the two sliders, and on the inner of the two sliders a corresponding dovetail that engages into the dovetail-shaped recess of the outer slider.

In a further advantageous embodiment, the stationary guide bar encompasses an opening and/or a receiving apparatus for reception of the cassette. This makes possible, in simple fashion, introduction of the cassettes into the cassette changing apparatus; especially when the opening is embodied on an upper side of the guide bar, gravity can be used in particularly simple fashion to introduce the cassette into the guide bar.

It is particularly advantageous in this context if the receiving apparatus encompasses a receiving chute. This contributes to the simple configuration of the receiving apparatus, and to reliable introduction of the cassette into the guide bar.

In a further advantageous embodiment, the receiving apparatus encompasses a scanner window for detection of a received cassette. This makes it possible, in simple fashion, to detect which cassette is presently located in the receiving apparatus.

In a further advantageous embodiment, the receiving apparatus is coupled to a magazine that is embodied to receive cassettes and to insert the cassettes into the receiving apparatus. This contributes in simple fashion to fast and/or automatic changing of the cassettes.

In a further advantageous embodiment, one or more predefined positions of the first and/or the second slider are predefined by springs working against one another and/or by one or more ball catches. This contributes to particularly precise positioning of the second slider and thus of the cassette, and is particularly advantageous when the first and/or the second slider is moved manually.

### BRIEF DESCRIPTION OF THE DRAWINGS

Exemplifying embodiments of the invention are explained in further detail below with reference to schematic drawings, in which:

FIG. 1 shows a microtome having a cassette changing apparatus;

FIG. 2 shows the cassette changing apparatus;

FIG. 3 is a section through the cassette changing apparatus;

FIG. 4 shows the cassette changing apparatus in a neutral position;

FIG. 5 shows the cassette changing apparatus in a loading position;

FIG. 6 shows the cassette changing apparatus in a clamp position;

FIG. 7 shows the cassette changing apparatus in a neutral position; and

FIG. 8 shows the cassette changing apparatus in an ejection position.

### DETAILED DESCRIPTION OF THE DRAWINGS

Elements of identical design and function are labeled with the same reference characters throughout the Figures.

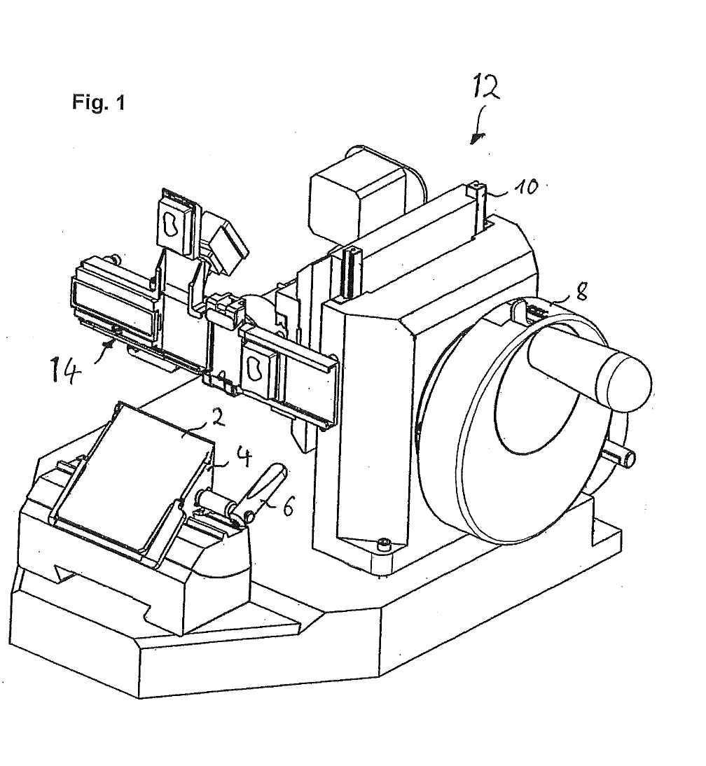

FIG. 1 shows a microtome 12 having a knife 2 for sectioning very thin slices of samples. Knife 2 is held by an adjustable knife holder 4 that is adjustable by means of a setting element 6. A handwheel 8 enables vertical displacement of a vertical guide 10 on which a cassette changing apparatus 14 is mounted. Rotation of the handwheel thus causes a sample in the cassette changing apparatus 14 to be movable toward knife 2 and back into the original position.

Cassette changing apparatus 14 contributes to the simple, fast, precise, and/or safe sectioning of samples that are to be sectioned. It contributes to safe sectioning of the samples when a user of microtome 12 can maintain the greatest possible safety distance from knife 2, since knife 2 is exposed and is preferably very sharp. Microtome 12 is nevertheless also convenient to operate thanks to cassette changing apparatus 14, despite the large possible safety distance.

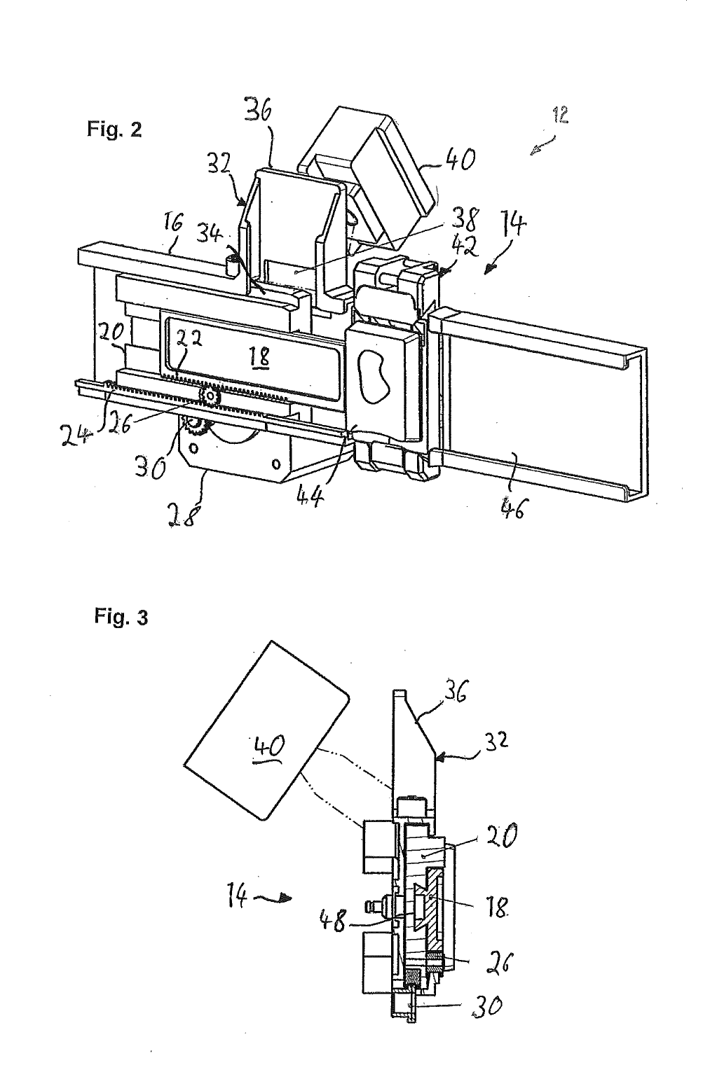

FIG. 2 shows cassette changing apparatus 14 with a first slider 18 and a second slider 20. First slider 18 is provided for displacement of a cassette 44 that holds the sample to be sectioned in a paraffin block. First slider 18 comprises a first toothed rack 22 and is guided movably in a guide of second slider 20. Second slider 20 is guided movably in a stationary guide bar 16. The stationary guide bar 16 comprises a second toothed rack 24. A gear 26 is mounted rotatably on second slider 20 in such a way that teeth of gear 26 engage on the one hand into first toothed rack 22 and on the other hand into second toothed rack 24. A particularly compact design for cassette changing apparatus 14 is preferably made possible by the fact that the stationary guide bar 16 not only guided first and/or second slider 18, 20, but is also embodied as a guide for cassette 44.

When second slider 20 is moved, first slider 18 thus also moves with it, since it is guided by second slider 20. An additional effect of toothed racks 22, 24 and gear 26 is that as second slider 20 moves, first slider 18 is moved relative to second slider 20, specifically by an amount equal to a multiple of the distance traveled by second slider 20 relative to the stationary guide bar 16, and at a multiple of the speed of second slider 20. In particular, first slider 18 travels exactly twice the distance, at twice the speed, as compared with slider 20,. This enables a particularly compact design for cassette changing apparatus 14, and contributes in simple fashion to safe interaction with microtome 12, since a particularly large safety distance can thereby be maintained by the operator of microtome 12, especially when second slider 20 is operated manually.

Guidance of second slider 20 in the stationary guide bar 16 is preferably achieved in particularly simple fashion by the fact that the stationary guide bar 16 is embodied in substantially U-shaped fashion, one longitudinal edge of guide bar 16 merely being bent inward in such a way that second slider 20 is held in the stationary guide bar 16. Guidance of first slider 18 in second slider 20 is preferably achieved in particularly simple fashion by the fact that second slider 20 is embodied in substantially U-shaped fashion.

A drive apparatus 28 is coupled, via a gear 30 of drive apparatus 28, to second slider 20 in order to move second slider 20.

Alternatively thereto, second slider 20 can be omitted and first slider 18 can be guided directly in the stationary guide bar 16, and is then preferably driven directly via gear 30 of drive apparatus 28.

As a further alternative thereto, drive apparatus 28 can be omitted, and first and/or second slider 18, 20 can then be moved manually.

As a further alternative to the exemplifying embodiment depicted, the stationary guide bar 16 can be arranged at least partly inside first and/or second slider 18, 20 and can thereby guide first and/or second slider 18, 20; and optionally, second slider 20 can then be arranged at least partly inside first slider 18. The guides themselves can then be embodied in accordance with the exemplifying embodiment depicted.

For simple introduction of cassettes 44 into cassette changing apparatus 14, a receiving apparatus 32 is preferably provided. Receiving apparatus 32 preferably comprises an opening 34 in the stationary guide bar 16, and a receiving chute 36. Receiving chute 36 holds cassettes 44 in a horizontal plane above opening 34. Gravity causes the introduction of cassettes 44 into guide bar 16 as soon as opening 34 is uncovered. Detection of a cassette 44 that is present in receiving chute 36 is possible, by preference, by the provision of a scanner window 38 through which, by means of a scanner 40, a code (e.g. a bar code) on cassette 44 is readable.

A clamp 42 that belongs to the processing apparatus of microtome 12 is provided for the processing of cassette 44, in particular for sectioning the sample of cassette 44. After cassette 44 has been processed, it is preferably transported into a removal bar 46.

Visible in the sectioned depiction of FIG. 3 is a dovetail guide 48 with which first slider 18 is guided in second slider 20 in addition to the U-shape of second slider. Alternatively or additionally, second slider 20 can be guided in the stationary guide bar 16 by way of a corresponding dovetail guide. Furthermore, alternatively or additionally, one longitudinal edge of second slider 20 can be bent inward correspondingly to the stationary guide bar 16.

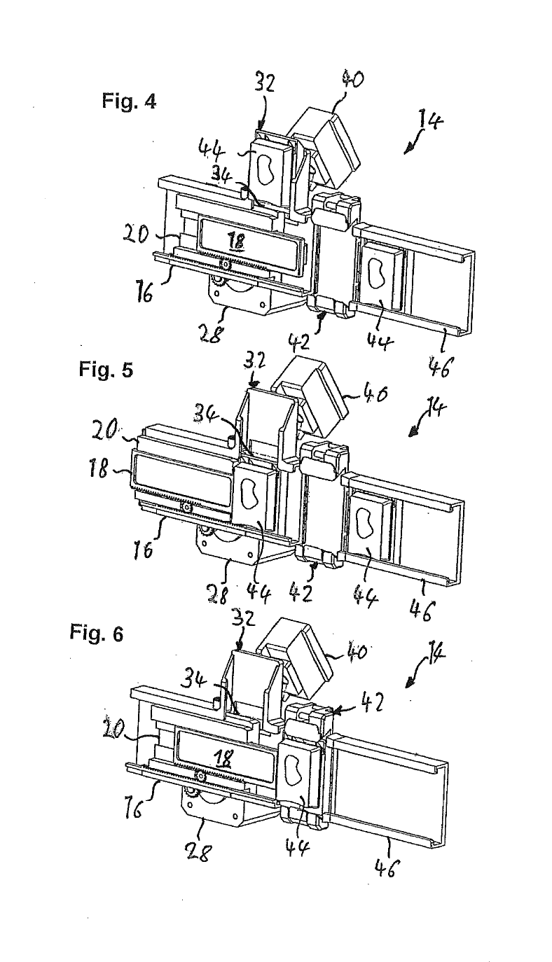

FIG. 4 shows cassette changing apparatus 14 in a neutral position. In the neutral position, second slider 20 closes off opening 34 in the stationary guide bar 16, so that cassette 44 can be placed into receiving apparatus 32 without sliding into the stationary guide bar 16. In the neutral position a cassette 44 can also be arranged in removal bar 46.

FIG. 5 shows a loading position of cassette changing apparatus 14. In the loading position, second slider 20 is moved in the direction away from clamp 42, resulting in a movement of first slider 18 away from clamp 42 until first and second slider 18, 20 uncover opening 34 and cassette 44 falls into the stationary guide rail 16. It is particularly advantageous in this context that upon any movement of second slider 20 inside the stationary guide bar 16, first slider 18 not only is moved along, with its guide, in second slider 20, but is additionally moved relative to second slider 20 by way of the two toothed racks 22, 24 and gear 26.

FIG. 6 shows cassette changing apparatus 14 in a clamp position. In the clamp position, second slider 20 is moved toward clamp 42, which results in a movement of first slider 18 toward 42, once again at twice the speed and over twice the distance as compared with second slider 20. First slider 18 slides cassette 44 into the stationary guide bar 16 until cassette 44 is completely received by clamp 42.

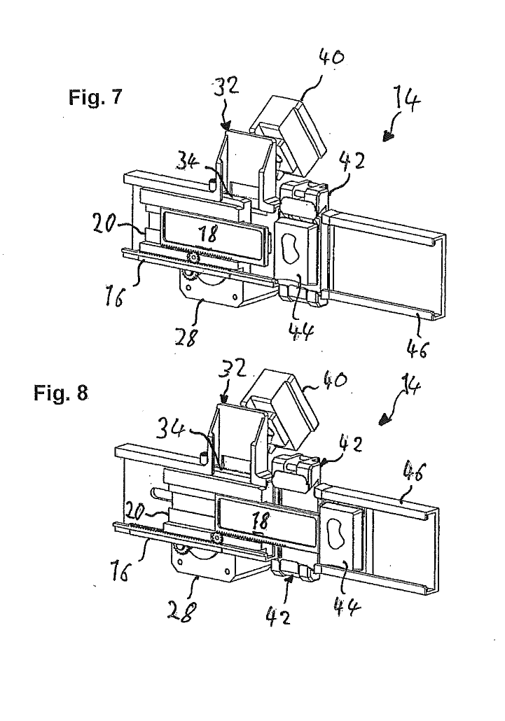

FIG. 7 once again shows the neutral position, in which no cassette 44 is in the receiving apparatus 32 and in which cassette 44 in clamp 42 is uncovered for processing by means of the sectioning apparatus of microtome 12.

FIG. 8 shows cassette changing apparatus 14 in an ejection position. In the ejection position, opening 34 of receiving apparatus 32 is closed off by second slider 20. Cassette 44 is also transported by means of first slider 18 into removal bar 46. Removal bar 46 can be emptied or changed both between the individual positions and after the ejection position is reached.

### LIST OF REFERENCE NUMERALS

2 Knife
4 Knife holder
6 Setting element
8 Handwheel
10 Vertical guide
12 Microtome
14 Cassette changing apparatus
16 Guide bar
18 First slider
20 Second slider
22 First toothed rack
24 Second toothed rack
26 Gear
28 Drive apparatus
30 Gear
32 Receiving apparatus
34 Opening
36 Receiving chute
40 Scanner
42 Clamp
44 Cassette
46 Removal bar
48 Dovetail guide

What is claimed is:

1. A microtome comprising a cassette changing apparatus that comprises:
a stationary guide bar;
a first slider adapted to displace a cassette;
a second slider that is guided movably by the stationary guide bar and adapted to guide the first slider; and
a coupling means adapted to couple the first and the second slider to each other such that a movement of the second slider along the stationary guide bar operates a movement of the first slider along with the second slider and additionally relative to the second slider.

2. The microtome according to claim 1, wherein the cassette changing apparatus comprises a removal bar that is arranged such that the cassette is displaceable into the removal bar by means of at least one of the first and the second slider.

3. The microtome according to claim 1, wherein the stationary guide bar is a guide for at least the one cassette.

4. The microtome according to claim 1, wherein the coupling means is adapted to couple the first and the second slider to each other such that movement of the second slider by a first distance results in a movement of the first slider by a second distance that is multiple times as long as the first distance.

5. The microtome according to claim 4, wherein the first slider comprises a first toothed rack, the stationary guide bar comprises a second toothed rack, and a gear having teeth is mounted rotatably on the second slider between the first and the second toothed rack so that the teeth mesh with the first and the second toothed rack.

6. The microtome according to claim 1, wherein at least one of the first and the second slider are coupled to a drive apparatus in order to move the first and the second slider, respectively.

7. The microtome according to claim 1, wherein at least one of the guides for the first and the second slider is a dovetail guide.

8. The microtome according to claims 3, wherein the stationary guide bar comprises at least one of an opening and a receiving apparatus for receiving the cassette.

9. The microtome according to claim 8, wherein the receiving apparatus comprises a receiving chute.

10. The microtome according to claim 8, wherein the receiving apparatus comprises a scanner window adapted to detect a received cassette.

11. The microtome according to one of claim 8, wherein the receiving apparatus is coupled to a magazine that is embodied to receive cassettes and to insert the cassettes into the receiving apparatus.

12. The microtome according to claim 1, wherein one or more predefined positions of at least one of the first and the second slider are predefined by at least one of springs working against one another and one or more ball catches.
